(19) United States
(12) Patent Application Publication
(10) Pub. No.: US 2015/0088696 A1
(43) Pub. Date: Mar. 26, 2015

(54) DYNAMIC DETERMINATION OF INVENTORY PROTOCOL

(71) Applicant: International Business Machines Corporation, Armonk, NY (US)

(72) Inventors: Eugene Amigud, Northborough, MA (US); Marco Deluca, Maple (CA); Leho Nigul, Richmond Hill (CA); Amy L. Tennent, Falmouth, ME (US)

(21) Appl. No.: 14/316,930

(22) Filed: Jun. 27, 2014

Related U.S. Application Data
(63) Continuation of application No. 14/034,736, filed on Sep. 24, 2013.

(51) Int. Cl. G06Q 30/06; G06Q 10/10

(52) U.S. Cl. CPC G06Q 30/0635; G06Q 10/10
USPC 705/26.81

(57) ABSTRACT

Embodiments of the present invention provide a system, method, and program product to dynamically determine inventory reservation protocols using dynamic shopper trends. In an embodiment, a computing device receives an order request for a product. The computing device determines a threshold criteria that is associated with the product as well as an inventory reservation protocol for the order request using the determined threshold criteria. The computing device also services the order request according to the determined inventory reservation protocol

### BACKGROUND

The present disclosure relates generally to the field of inventory management, and more particularly to dynamic determination of inventory reservation protocols using dynamic shopper trends. Inventory management is the process of efficiently overseeing the constant flow of units into and out of an existing inventory. This process usually involves controlling the transfer in of units in order to prevent the inventory from becoming too high, or dwindling to levels that could put the operation of the company into jeopardy. Inventory management software tracks inventory levels, orders, sales and deliveries. Companies use inventory management software to avoid product overstock and outages.

In some current commerce scenarios, after a shopper has placed an order, the inventory to support the order is reserved (hereinafter “inventory reservation”) to ensure that the order can be properly sourced by the vendor. The need for inventory management systems to make such inventory reservations usually creates a significant performance bottle neck. One existing solution uses the assumption that stock of the ordered item will always be available, and therefore, no reservation is placed. This solution may become somewhat problematic if some items suddenly sellout. Other existing solutions call for the use of synchronous reservation calls wherein a reservation is placed once inventory availability has been confirmed.

### SUMMARY

Embodiments of the present invention provide a system, method, and program product to dynamically determine inventory reservation protocols using dynamic shopper trends. In an embodiment, a computing device receives an order request for a product. The computing device determines a threshold criteria that is associated with the product as well as an inventory reservation protocol for the order request using the determined threshold criteria. The computing device also services the order request according to the determined inventory reservation protocol.

### BRIEF DESCRIPTION OF THE SEVERAL VIEWS OF THE DRAWINGS

FIG. 1 is a block diagram illustrating an environment, in accordance with an embodiment of the present invention.

FIG. 2 depicts information transmissions between the exemplary servers and the computing device of FIG. 1, in accordance with an embodiment of the present invention.

FIG. 3 illustrates operational steps of a program function, in accordance with an embodiment of the present invention.

FIG. 4 depicts a block diagram of components of the exemplary server executing the program function, in accordance with an illustrative embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

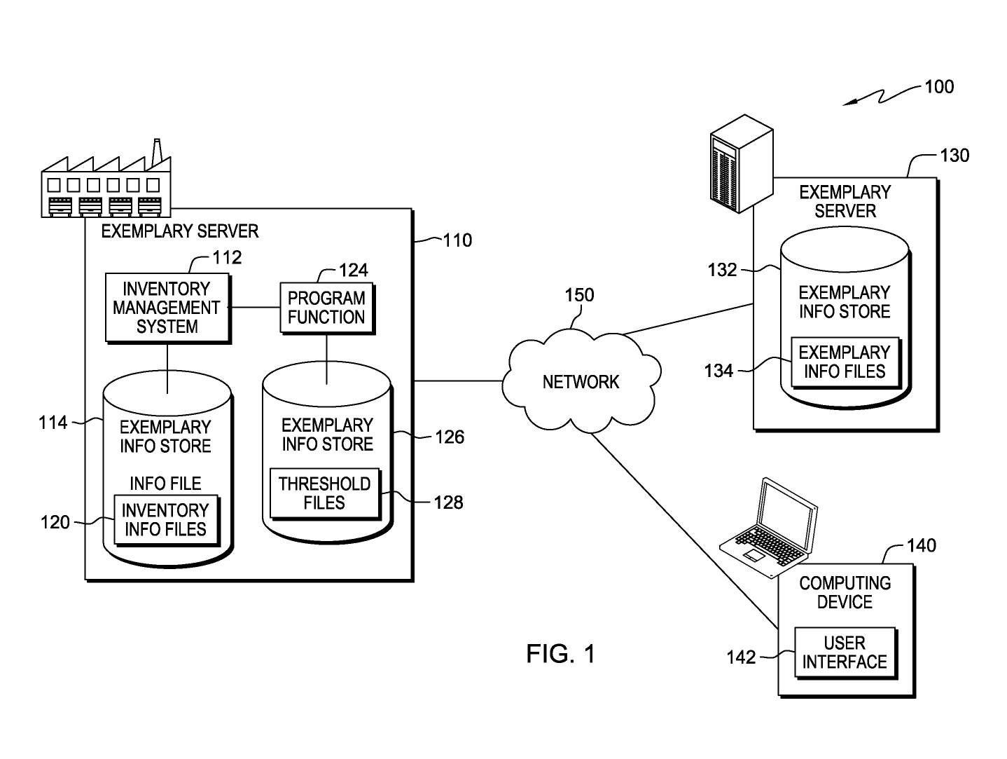

Embodiments of the present invention will now be described in detail with reference to the Figures. FIG. 1 is a block diagram illustrating an environment, generally designated 100, in accordance with an embodiment of the present invention. Environment 100 is an electronic commerce (hereinafter “e-commerce”) environment wherein products are bought and/or sold over a network. Environment 100 includes computing device 140 and exemplary servers 110 and 130, all interconnected via network 150. In another embodiment, environment 100 only includes exemplary servers 110 and 130, such as environments where product orders are placed via a call center. Network 150 can be, for example, a local area network (LAN), a wide area network (WAN) such as the Internet, or a combination of the two, and can include wired, wireless, or fiber optic connections. In general, network 150 can be any combination of connections and protocols that will support communications between computing device 140 and exemplary servers 110 and 130.

In various embodiments of the present invention, computing device 140 and exemplary servers 130 and 110 may be a laptop computer, tablet computer, netbook computer, personal computer (PC), a desktop computer, a personal digital assistant (PDA), a smart phone, or any programmable electronic device capable of communicating with another programmable electronic device via network 150. Computing device 140 is in communication with exemplary servers 110 and 130 via network 150.

Computing device 140 is a computing device that is used to order products from a seller. For example, the seller can be associated with a website, such as a website hosted on exemplary server 130. The seller may also be associated with a brick-and-mortar location, such as a call center. Computing device 140 includes user interface 142, which allows a user of computing device 140 to interact with computing device 140, access network 150, and/or place an order for products from a seller, such as a seller associated with exemplary server 130. In an embodiment, user interface 142 is a text-based, a graphics-based, a touch screen, and/or a gesture interface. In general, user interface 142 is any user interface that allows a user of computing device 140 to order products from a website that is hosted by exemplary server 130, in accordance with an embodiment of the present invention.

Exemplary server 130 is in communication with computing device 140 and exemplary server 110 via network 150, in accordance with an embodiment of the present invention. Exemplary server 130 is a computing device that hosts e-commerce websites. Exemplary server 130 includes exemplary information store 132, which is an information repository. Exemplary information store 132 includes exemplary information files 134, which are files that support the e-commerce websites hosted by exemplary server 130. In an embodiment, exemplary information files 134 include e-commerce web pages and associated product information. In other embodiments, exemplary information store 132 is included in exemplary server 130. Exemplary server 130 receives, via network 150, orders transmitted by computing device 140. Exemplary server 130 transmits, via network 150, received orders to exemplary server 130 for servicing.

Exemplary server 110 is in communication with computing device 140 and exemplary server 130, via network 150. Exemplary server 110 is an application server that provides inventory management services, in accordance with an embodiment of the present invention. Exemplary server 110 includes inventory management system 112, exemplary information stores 114 and 126, and program function 124. Inventory management system 112 includes exemplary information store 114, which is an information repository and is in communication with program function 124. Inventory management system 112 tracks inventory levels, orders, sales, and deliveries. Inventory management system 112 generates order confirmations. Inventory management system 112 also generates product burn rates (discussed below). Inventory management system 112 also generates product burn rates for products included in inventory data 120.

Inventory management system 112 transmits, via network 150, generated order confirmations to exemplary server 110. Exemplary information store 114 includes inventory information files 120. In an embodiment, inventory information files 120 include current and/or historical product sales information, such as productID, quantity sold, time of sale, and/or available quantity. In certain embodiment, productID is a stock-keeping unit. In another embodiment, inventory information files 120 include Table 1

TABLE 1

| | Quantity | | Quantity |
|---|---|---|---|
| Product ID | Sold | Time of Sale | Available |
| 1234 | 20 | 8/1/2013 0:35 | 80 |
| 3456 | 10 | 8/1/2013 1:35 | 90 |
| 5678 | 5 | 7/15/2013 20:35 | 95 |
| 7890 | 1 | 7/10/2013 6:27 | 99 |

Program function 124 is in communication with inventory management system 112 and exemplary information store 126, in accordance with an embodiment of the present invention. Exemplary information store 126 is an information repository that includes threshold files 128. Threshold files 128 are files that are associated with a product listed in inventory information files 120 and include a threshold number and/or rate reflective of a product's popularity. In an embodiment, threshold files 128 are the rules by which product popularity is determined. For example, the threshold value for productID 1234 is ten percent (10%) of inventory per day; hence, when ten percent or more of productID 1234 is sold within a 24-hour time period, that product is “popular”.

In an embodiment, the threshold value is associated with website traffic. For example, a product is deemed popular, if at least a certain percentage, such as ten percent (10%), of the day's website traffic is associated with that particular product. In another embodiment, threshold rate is also associated with burn down rate, which is the rate at which a product sells out, wherein inventory management system 112 can be instructed to generate a new burn down rate for a product when it is determined that the item's website traffic increased above its threshold value. In another embodiment, the threshold value is associated with the product's burn rate. For example, a product is determined to be popular if it has a particular burn rate, such as thirty (30) items per hour. Program function 124 is software that automatically determines the proper inventory reservation protocol based on dynamic product demand trends to ensure that orders are properly serviced. Applicable inventory reservation protocols include those that require synchronous reservation calls, non-synchronous reservation calls, and no reservation calls.

A reservation call reserves a product for sale and/or shipment. However, reservation calls can decrease the performance of inventory management systems, such as inventory management system 112, if a reservation call is made needlessly. For example, synchronous reservation calls require the determination of product availability prior to the generation of an order confirmation, which increases order servicing time compared to non-synchronous reservation calls, which require the generation of an order confirmation without a prior determination of product availability, which may occur later. Further, where product availability is certain, a reservation call is needless; hence, no reservation call should be made. Program function 124 determines whether an order received from exemplary server 130 requires a synchronous reservation call, non-synchronous reservation call, or no reservation call. Program function 124 determines the popularity of products listed in inventory information files 120.

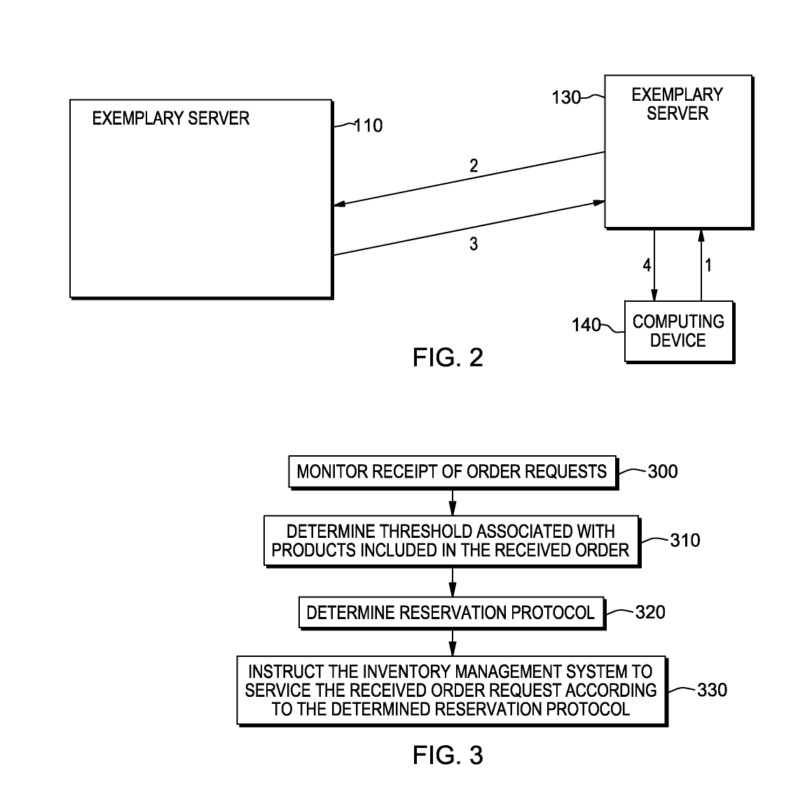

Program function 124 utilizes information included in threshold files 128 in order to determine product popularity (discussed above). Specifically, FIG. 2 illustrates an embodiment of the present invention wherein an order for a product is placed and serviced. Program function 124 reduce performance bottlenecks experienced by inventory management system 112 that result from servicing unnecessary inventory reservations received from exemplary server 130 by ensuring that the proper reservation protocol is placed. Concepts introduced in the following discussion of FIG. 2 will be used further in the discussion of FIG. 3 in the context of environment 100 of FIG. 1.

FIG. 2 depicts information transmissions (hereinafter “transmission”) between the exemplary servers 110 and 130 and computing device 140, in accordance with an embodiment of the present invention. In particular, transmission 1 initiates when a user of computing device 140 visits a website hosted by exemplary server 130 and places an order for productID 1234 using user interface 142, which transmits the order to exemplary server 130 via network 150. Transmission 2 initiates when exemplary server 130 receives the order from computing device 140 and transmits the order to inventory management system 112 via network 150. Program function 124 determines that an inventory reservation request was received by inventory management system 112.

Program function 124 retrieves the threshold files that are associated with the products included in the order request from threshold files 128. For example, the threshold file for productID 1234 reflects that productID 1234 is considered popular if at least twenty (20) items of the product are sold in a day. Using the information supplied in Table 1 (discussed above), program function 124 determines that as of today, Aug. 1, 2013, twenty (20) items of productID 1234 have sold. Hence, in response to the determination, program function 124 generates a synchronous reservation call for productID 124 and instructs inventory management system 112 to determine the availability of productID 1234 before transmitting an order confirmation to exemplary server 130.

If inventory management system 112 determines that productID 1234 is available in a quantity sufficient to service the order request, inventory management system 112 then services the request by initiating transmission 3 by transmitting an order confirmation to exemplary server 130. In another example, if the threshold file for productID 1234 reflects that the item is considered popular if at least thirty (30) items of the product are sold in a day, then, according to Table 1, program function 124 determines that productID 1234 is not currently considered popular. In response to the determination, program function 124 asynchronously instructs inventory management system 112 to generate and transmit an order confirmation to exemplary server 130 (transmission 3).

In yet another example, where the availability of productID 1234 will never run out, for example, because the manufacturer of the product has guaranteed to backfill any orders for productID 1234 within two (2) days, then productID 1234 will have no threshold file in threshold files 128. If program function 124 determines that a product included in an order request has no associated threshold file, then program function 124 instructs inventory management system 112 to generate and transmit an order confirmation to exemplary server 130 via network 150. In response to receiving the order confirmation, exemplary server 130 transmits the order confirmation to computing device 140 without making a synchronous reservation call (transmission 4).

FIG. 3 illustrates the operational steps of program function 124, in accordance with an embodiment of the present invention. Program function 124 monitors the receipt of order requests (step 300). Program function 124 determines the thresholds associated with the products listed in the received order request (step 310). Program function 124 determines the reservation protocol (step 320). Program function 124 instructs inventory management system 112 to service the received order request according to the determined reservation protocol (step 330).

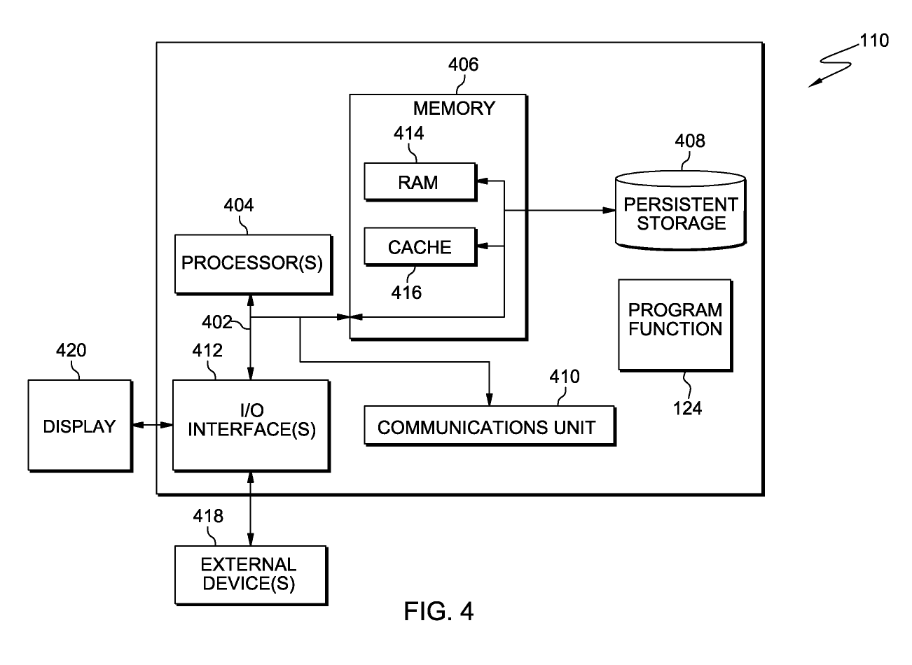

FIG. 4 depicts a block diagram of components of exemplary server 110, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Exemplary server 110 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Program function 124, inventory management system 112, and exemplary information store 114 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of exemplary server 130 and computing device 140. In these examples, communications unit 410 includes one or more network interface cards. Communications unit 410 may provide communications through the use of either or both physical and wireless communications links. Program function 124 and inventory management system 112 may be downloaded to persistent storage 408 through communications unit 410.

I/O interface(s) 412 allows for input and output of data with other devices that may be connected to exemplary server 110. For example, I/O interface 412 may provide a connection to external device(s) 418 such as a keyboard, a keypad, a touch screen, and/or some other suitable input device. External device(s) 418 can also include portable computer-readable storage media such as, for example, thumb drives, portable optical or magnetic disks, and memory cards. Software and data used to practice embodiments of the present invention, e.g., program function 124 and inventory management system 112, can be stored on such portable computer-readable storage media and can be loaded onto persistent storage 408 via I/O interface(s) 412. I/O interface(s) 412 also connects to a display 420. Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method comprising:
a computing device receiving an order request for a product;
determining a threshold criteria associated with the product;
determining an inventory reservation protocol for the order request using the determined threshold criteria; and
servicing the order request according to the determined inventory reservation protocol.

2. The method of claim 1, wherein the threshold criteria is associated with a rate and/or number.

3. The method of claim 1, wherein the inventory reservation protocol is one of the following:
generating an order confirmation after determining availability of the product;
generating an order confirmation before determining availability of the product; and
generating an order confirmation without determining availability of the product.

4. The method of claim 3, wherein the order confirmation is generated after determining the availability of the product if the determined threshold criteria is satisfied.

5. The method of claim 3, wherein the order confirmation is generated before determining the availability of the product if the determined threshold criteria is not satisfied.

6. The method of claim 3, wherein the determined reservation protocol is a no reservation call if there is no determined threshold criteria associated with the product because the availability of the product is certain.
